(19) United States
(12) Patent Application Publication
(10) Pub. No.: US 2005/0137341 A1
(43) Pub. Date: Jun. 23, 2005

(54) Foamable polyvinyl chloride compound tolerant of high heat conditions

(76) Inventors: Roman B. Hawrylko, Avon Lake, OH (US); Mark Learn, Bolton (CA)

Correspondence Address: John H. Hornickel, PolyOne Corporation, 33587 Walker Road, Avon Lake, OH, 44012, US

(21) Appl. No.: 11/001,909

(22) Filed: Dec. 2, 2004

Related U.S. Application Data
(60) Provisional application No. 60/529,636, filed on Dec. 11, 2003.

(51) Int. Cl. C08L 35/00

(52) U.S. Cl. 525/205

(57) ABSTRACT

A foamable PVC compound is disclosed. The compound comprises polyvinyl chloride, heat deflection temperature modifier, and optionally, a blowing agent. Conventional additives are optionally present. Profile extruded, foamed articles can be made with the compound.

### CLAIM OF PRIORITY

This application claims priority from U.S. Provisional Patent Application Ser. No. 60/529,636 bearing Attorney Docket Number 12003027 and filed on Dec. 11, 2003.

### FIELD OF THE INVENTION

This invention relates to compounds containing foamable polyvinyl chloride compounds prepared from dry blends or cube/pellets.

### BACKGROUND OF THE INVENTION

Polyvinyl chloride (PVC) is an excellent thermoplastic polymer for a wide variety of consumer and commercial uses. PVC polymer is mixed intimately with a number of other ingredients to form valuable PVC compounds that have very specialized properties for the ultimate intended use. One of these uses is as window treatments such as slats for window blinds, either vertical or horizontal in orientation.

Co-owned U.S. Pat. Nos. 5,119,871; 5,198,170; 5,358,024; 5,496,630; and 5,536,462 (all of which are incorporated by reference as if rewritten herein) disclose several different aspects of the compounding and manufacture of window treatments having a variety of appearances.

U.S. Pat. No. 5,198,170 discloses considerable detail about the manufacture of PVC extruded articles from powdered, cube, or pellet PVC compounds. For example, one use of an exemplary PVC profile derived from powder compounds is a vertical louver. PVC vertical louvers are commercially abundant and are formulated from general purpose extrusion grade PVC having an inherent viscosity (I.V.) of from about 0.68 to 1.0. High bulk density, low porosity resins formulated into extrusion powder compounds require higher shear and temperatures in order to achieve adequate breakdown into primary PVC particles which then fuse in the extrusion process.

U.S. Pat. No. 3,975,315 discloses expandable rigid vinyl chloride polymer compositions prepared from mixtures of high molecular weight vinyl chloride polymers and copolymers of a styrene and an acrylonitrile or alkyl methacrylate, optionally with a polymer of butadiene, styrene and acrylonitrile, and a blowing agent, without the use of plasticizers, solvents or cross-linking agents. The styrene polymer comprises from 5 to 20 parts per 100 parts of polyvinyl chloride.

Window treatments are a decorative article as well as a functional article.

### SUMMARY OF THE INVENTION

What the art needs is a PVC compound that is capable of being foamed to create an extrusion profile for window treatments and other articles and which is capable of having high temperature resistance to maintain dimensional stability.

The present invention solves this problem by providing a high heat PVC compound that can be foamed.

More particularly, the use of Heat Deflection Temperature (HDT) modifiers provides adequate melt elasticity for encapsulation of gas emitted by blowing agents also present in the PVC compound.

It has been found that high molecular weight HDT modifiers can provide the desired melt elasticity in the absence of conventional foam PVC processing aides.

“HDT modifiers” or “heat deflection temperature modifiers” means polymeric additives which when alloyed with PVC, increase the heat distortion temperature properties of the PVC. HDT modifiers are distinguished from conventional foam PVC processing aides because they are high molecular weight polymers with significantly higher glass transition temperatures (Tg's) and HDT's than rigid PVC. HDT modifiers are compatible with PVC and form miscible blends with PVC. These HDT modifiers also have higher Tg's and HDT's than conventional acrylic, acrylonitrile-butadiene-styrene (ABS) and styrene-acryonitrile (SAN) processing aids or impact modifiers.

The use of HDT modifiers in PVC compounds of the present invention allows articles to be made by extrusion, either single or multi-screw extrusion, of a powder, cube, or pellet compound to produce an extruded article.

One aspect of the present invention is a foamable polyvinyl chloride compound, comprising polyvinyl chloride, heat deflection temperature modifier, and, optionally, a blowing agent, wherein the amount of heat deflection temperature modifier is at least 25 parts per 100 parts of polyvinyl chloride.

Another aspect of the present invention is a method of making the foamable PVC compound.

Another aspect of the present invention is a method of using the foamable PVC compound by extruding that compound to make a foamed profile.

Features and advantages of the invention will be discussed with respect to embodiments thereof.

### EMBODIMENTS OF THE INVENTION

PVC Resin

The PVC compound has a PVC resin having
(a) a particle size average in a range of about 50 μm to 125 μm, preferably in a range of 60 μm to 115 μm, more preferably in a range of from 70 μm to 100 μm;
(b) a DOP porosity from about 0.27 cc/gm to about 0.50 cc/gm, preferably from 0.44 cc/gm to about 0.50 cc/gm; and
(c) a friability rating, defined herein, of 5 or less, preferably 1 or 2, and most preferably a friability rating of zero.

Polyvinyl chloride polymers are widely available throughout the world. Polyvinyl chloride resin as referred to in this specification includes polyvinyl chloride homopolymers, vinyl chloride copolymers, graft copolymers, and vinyl halide polymers polymerized in the presence of any other polymer such as a HDT distortion temperature enhancing polymer, impact toughener, barrier polymer, chain transfer agent, stabilizer, plasticizer or flow modifier.

For example a combination of modifications may be made with the PVC polymer by overpolymerizing a low viscosity, high glass transition temperature (Tg) enhancing agent such as SAN resin, or an imidized polymethacrylate in the presence of a chain transfer agent.

In another alternative, vinyl chloride may be polymerized in the presence of said Tg enhancing agent, the agent having been formed prior to or during the vinyl chloride polymerization. However, only those resins possessing the specified average particle size and degree of friability exhibit the advantages applicable to the practice of the present invention.

In the practice of the invention, there may be used polyvinyl chloride homopolymers or copolymers of polyvinyl chloride comprising one or more comonomers copolymerizable therewith. Suitable comonomers for vinyl chloride include acrylic and methacrylic acids; esters of acrylic and methacrylic acid, wherein the ester portion has from 1 to 12 carbon atoms, for example methyl, ethyl, butyl and ethylhexyl acrylates and the like; methyl, ethyl and butyl methacrylates and the like; hydroxyalkyl esters of acrylic and methacrylic acid, for example hydroxymethyl acrylate, hydroxyethyl acrylate, hydroxyethyl methacrylate and the like; glycidyl esters of acrylic and methacrylic acid, for example glycidyl acrylate, glycidyl methacrylate and the like; alpha, beta unsaturated dicarboxylic acids and their anhydrides, for example maleic acid, fumaric acid, itaconic acid and acid anhydrides of these, and the like; acrylamide and methacrylamide; acrylonitrile and methacrylonitrile; maleimides, for example, N-cyclohexyl maleimide; olefin, for example ethylene, propylene, isobutylene, hexene, and the like; vinylidene halide, for example, vinylidene chloride; vinyl ester, for example vinyl acetate; vinyl ether, for example methyl vinyl ether, allyl glycidyl ether, n-butyl vinyl ether and the like; crosslinking monomers, for example diallyl phthalate, ethylene glycol dimethacrylate, methylene bis-acrylamide, tracrylyl triazine, divinyl ether, allyl silanes and the like; and including mixtures of any of the above comonomers.

The preferred composition is a polyvinyl chloride homopolymer.

Commercially available sources of polyvinyl chloride polymers include Oxyvinyls LP of Dallas, Tex. and Shin Tech USA of Freeport, Tex.

PVC Compounds

Rigid or flexible powder PVC resin compounds typically contain a variety of components selected according to the performance requirements of the article produced therefrom and beyond the scope of the present invention. The powder compounds used herein contain effective amounts of these components ranging from 0.01 to about 500 weight parts per 100 weight parts PVC (parts per hundred resin-phr).

For example, various primary and/or secondary lubricants such as oxidized polyethylene, high melt flow polypropylene, paraffin wax, fatty acids, and fatty esters and the like can be utilized.

Thermal and ultra-violet light (UV) stabilizers can be utilized such as various organo tins, for example dibutyl tin, dibutyltin-S—S′-bi-(isooctylmercaptoacetate), dibutyl tin dilaurate, dimethyl tin diisooctylthioglycolate. Secondary stabilizers may be included for example a metal salt of phosphoric acid, polyols, and epoxidized oils. Specific examples of salts include water-soluble, alkali metal phosphate salts, disodium hydrogen phosphate, orthophosphates such as mono-, di-, and tri-orthophosphates of said alkali metals, alkali metal polyphosphates, -tetrapolyphosphates and -metaphosphates and the like. Polyols such as sugar alcohols, and epoxides such as epoxidized soya oil can be used. Typical levels of secondary stabilizers range from about 0.1 wt. parts to about 7.0 wt. parts per 100 wt. parts PVC (phr).

In addition, antioxidants such as phenolics, BHT, BHA, various hindered phenols and various inhibitors like substituted benzophenones can be utilized.

When increased impact values are desired, impact modifiers can be included which are known to the art. For example, various impact modifiers are set forth in The Encyclopedia of PVC, Volume 2, Chapter 12, Marcel Dekker, Inc., New York, 1977, which is hereby incorporated by reference. Specific examples of impact modifiers include various acrylonitrile-butadiene-styrene (ABS) polymers, the various chlorinated polyethylenes, the various graft copolymers of acrylic rubbers, the various poly(ethylene-co-vinyl acetates), styrene-butadiene-styrene block copolymers, graft copolymers of methylmethacrylate, butadiene and styrene (MBS), graft copolymers of acrylonitrile, butadiene and styrene (ABS) and the like. Impact modifiers of these types are commercially available. Preferred impact modifiers include ABS, MBS, graft copolymers of acrylic rubbers, chlorinated polyethylene and mixtures. Regardless of the particular impact modifier utilized, the amounts thereof can naturally vary, depending upon the desired impact strength as typically measured by an Izod impact test (ASTM D256). The levels of impact modifier present typically vary from about 3 to about 30 phr. Accordingly, articles derived from the powder compounds of the present invention have the capacity to be impact-modified to achieve notched Izod values generally in excess of in excess of 100 N/m² if desired.

Various processing aids, fillers, pigments and reinforcing materials can also be utilized in amounts up to about 200 or 300 phr. Exemplary processing aids are acrylic polymers such as poly methyl acrylate based materials.

Adjustment of melt viscosity can be achieved as well as increasing melt strength by employing 0.5 to 5 phr of commercial acrylic process aids such as those from Rohm and Haas under the Paraloid® Trademark. Paraloid®. K-120ND, K-120N, K-175, and other processing aids are disclosed in The Plastics and Rubber Institute: International Conference on PVC Processing, Apr. 26-28 (1983), Paper No. 17.

Examples of fillers include calcium carbonate, clay, silica and various silicates, talc, carbon black and the like. Reinforcing materials include glass fibers, polymer fibers and cellulose fibers. Such fillers are generally added in amounts of from about 3 to about 100 phr of PVC. Preferably from 3 to 50 phr of filler are employed for extruded profiles such as louvers.

Examples of various pigments include titanium dioxide, carbon black and the like. Mixtures of fillers, pigments and/or reinforcing material also can be used.

Plasticizers may be included in any manner and amount. Exemplary plasticizers are set forth in The Technology of Plasticizers, by Sears and Darby, pages 893-1085, John Wiley and Sons, New York, 1982, which is incorporated herein by reference. Plasticizers are preferably absent, or present in minor amounts.

HDT Modifiers

The present invention uses HDT modifiers, as defined above, within the PVC compounds.

Non-limiting examples of such HDT modifiers include Blendex brand styrene-based compounds (such as Blendex 587 and 587S brand modifiers); Paraloid HT brand acrylate-based compounds (such as Paraloid HT 100 brand modifier); Baymod brand alpha-methyl SAN or ABS compounds (such as Baymod A VP SP-51012 and Baymod A VP SP-51013 brand modifiers), and combinations thereof. The Blendex brand compounds are commercially available from Crompton. The Paraloid brand compounds are commercially available from Rohm & Haas. The Baymod brand compounds are commercially available from Bayer.

Such HDT modifiers are generally added in amounts of at least about 25 parts per 100 parts (phr) of PVC, desirably from about 25 to about 100 parts phr of PVC, and preferably from 40 to 85 phr of HDT modifier are employed for extruded profiles such as louvers.

Optional Blowing Agent

Blowing agents expand during processing to generate gas-filled cavities in a polymer. Exothermic blowing agents, endothermic blowing agents, or both can be used in the present invention to generated a foamed extruded article from the PVC compound of the present invention. The blowing agent can be added to the PVC compound or can be added to the extruding equipment with the PVC compound. Thus, for purposes of this invention, the blowing agent is an optional ingredient for a dry blend mixture of the PVC compound of the present invention even if it is a required ingredient to make a foamed PVC extruded article. Thus, a “foamable” PVC compound of the present invention optionally has blowing agent included in the dry blend mixture.

Non-limiting examples of endothermic blowing agents are polycarbonic acids, coating sodium bicarbonate, coated citric acid, coated mono sodium citrate, and coated sodium citrate.

Exothermic blowing agents include azodicarbonamides, modified azodicarbonamides, oxybis benezene sulfony hydrazide (OBSH), toluenesulfonyhydrazides (TSH), 5-pheyltetrazole (5-PT), diisopropylhydrazodicarboxylate (DIHC), and dinitrosopentamethylenetetramine (DNPT). Suitable commercially available blowing agents are available from Mats Corp. Ltd. of Markham, Ontario as MS01, Cenblo Mat 100 or 500 (a carboxylic acid and carbonate based product), Uniroyal Chemical Company, Inc. of Middlebury, Conn., as Expandex® 5PT (a 5-phenyl tetrazole based product), EPI Environmental Plastics Inc. of Conroe, Tex., as EPIcor, Uniroyal Chemical Company of Middlebury, Conn., as Expandex and Reedy International Corp. of Keyport, N.J. as Safoam. A particularly preferred commercial blowing agent is Porofor ADC/MCI brand blowing agent from Bayer. Blowing agents are generally added in amounts of from about 0.01 to about 1 phr of PVC and preferably from 0.1 to 0.8 phr of blowing agent are employed for extruded profiles such as louvers.

Processing Foamable PVC Compound

The making of PVC of the present invention follows conventional techniques, such as a batch mixer that is capable of controlled heating conditions. The various conventional ingredients are added at temperatures known to those skilled in the art.

A Henschel mixer is preferably used because of its ability to substantially uniformly disperse the compound's ingredients. The mixer operates at a high rotation speed and moves in temperature from one established plateau to the next, ultimately concluding the mixing at a drop temperature of about 100° C.

Usefulness of the Invention

The foamable PVC compound can be pelletized for subsequent profile extrusion. Optionally, the blowing agent can be an ingredient of the foamable PVC compound or added with the foamable PVC compound to the conventional extrusion equipment. Use of conventional extrusion equipment permits the heating of the foamable PVC compound and the expansion (or foaming) of PVC compound for extrusion using any type of desired profile die to establish dimension of the ultimate extruded article.

A profile die for a window treatment such as a slat, louver, or other horizontally or vertically oriented window treatment member can have dimensions from about 2.5 cm to about 13 cm wide, and from about 0.3 cm to about 5 cm thick.

The following examples further explain the invention.

### EXAMPLES

Table 1 identifies the ingredients, their purposes and sources used in the Examples.

TABLE 1
Source of Ingredients

| | | | Commercial |
|---|---|---|---|
| Ingredient | Purpose | Generic Name | Source |
| SE950 EG | Plastic Resin | Polyvinyl chloride | Shin Tech |
| Mark 1900 | Stabilizer | Dimethyl tin mercapto | Crompton |
| | | acetate | |
| Witco F | Lubricant | Calcium stearate | Crompton |
| Rheolub 165 | Lubricant | Paraffin wax | Rheochem |
| AC629A | Lubricant | Oxidized polyethylene | Honeywell |
| | | wax | |
| Tiona RCL | Whitener | Titanium Dioxide | Millenium |
| Blendex 587 | HDT Modifier | Alpha-methyl | Crompton |
| | | Styrene/Styrene- | |
| | | acrylonitrile | |
| PARALOID | HDT Modifier | Methyl Methacrylate | Rohm & Haas |
| HT 100 | | | |
| Porofor | Blowing Agent | Azodicarbonamide | Bayer |
| ADC/MC1 | | | |
| Thermolite | Stabilizer | Tin stabilizer | Atofina |
| T31S | | | |
| 2301X36 | Process Aid | Styrene acrylonitrile | Zeon |
| | | based process aid | |
| Tyrin 3615P | Impact | Chlorinated polyethylene | DupontDow |
| | Modifier | | |
| Celogen | Blowing Agent | Modified | Crompton |
| AZRV | | azodicarbonamide | |
| Kemamide | Lubricant | EBS wax | Crompton |
| W40 | | | |
| Wax E | Lubricant | Montanic Acid Ester | Clariant |

Table 2 identifies the formulations, method of preparation, and resulting properties of each Examples 1-3.

TABLE 2
Recipes, Preparation, and Properties

| | Example 1 | | | | Example 3 | |
|---|---|---|---|---|---|---|
| | | PHR | Example 2 | | | PHR |
| | | of | | PHR of | | of |
| Ingredient | | PVC | | PVC | | PVC |
| SE950 EG | 55.0 | — | 70.0 | — | 55.0 | — |
| Mark 1900 | 1.0 | 1.8 | 1.0 | 1.4 | 1.0 | 1.8 |
| Witco F | 1.5 | 2.7 | 1.5 | 2.1 | 1.5 | 2.7 |
| Rheolub 165 | 1.0 | 1.8 | 1.0 | 1.4 | 1.0 | 1.8 |
| AC629A | 0.2 | 0.4 | 0.2 | 0.3 | 0.2 | 0.4 |
| Tiona RCL 188 | 5.0 | 9.1 | 5.0 | 7.1 | 5.0 | 9.1 |
| Blendex 587 | 45.0 | 81.8 | 30.0 | 42.9 | — | — |
| PARALOID HT 100 | — | — | — | — | 45.0 | 81.8 |
| Porofor ADC/MC1 | 0.4 | 0.7 | 0.4 | 0.6 | 0.4 | 0.7 |
| Total Weight | 109.1 | | 109.1 | | 109.1 | |

| Mixing Equipment | 100 L Henschel Mixer | | |
|---|---|---|---|
| Mixing Temp. | 220° F. (104° C.) Drop Temperature | | |
| Mixing Speed | Standard High Speed | | |
| Order of Addition of | Initial Charge of polyvinyl chloride + stabilizer | | |
| Ingredients | Lubricants and Blowing Agent added at | | |
| | 160° F. (71° C.) | | |
| | Modifier and Whitener at 180° F. (82° C.) | | |
| Form of Product After | Dry Blend Powder | | |
| Mixing | | | |
| Extrusion Equipment | 75 mm Davis-Standard Single Screw Extruder | | |
| | with 2 inch (5.1 cm) Profile Die Operating at | | |
| | 177-188° C. (350-370 ° F.) | | |
| Appearance of | Passed | Passed | Passed |
| Foamed Slat: | | | |
| Dimensions, Surface, | | | |
| Density | | | |
| 135° F. (57° C.) Oven | Passed | Passed | Passed |
| Sag Test | | | |

Table 2 shows that two different types of HDT modifier can be used in the same amount: Example 1 compared with Example 3. Moreover, the amount of HDT modifier present can be varied: Example 1 compared with Example 2.

Table 3 shows the formulations of Example 4 and Comparative Example A along with physical testing results. The preparation used the same techniques as for Examples 1-3.

TABLE 3

| | |
|---|---|
| Example Comp. A | Example 4 |

Recipes

| | | |
|---|---|---|
| Ingredient | | |
| SE950 EG | 100.0 | 100.0 |
| Thermolite T31S | 2.0 | 2.0 |
| 2301X36 | 10.0 | 10.0 |
| Tyrin 3615P | 3.0 | 3.0 |
| Kemamide W40 | 0.8 | 0.8 |
| Calcium Stearate | 1.0 | 1.0 |
| Wax E | 0.8 | 0.8 |
| Blendex 587 | — | 30.00 |
| Celogen AZRV | 0.8 | 0.8 |
| Tiona RCL 6 | 15.0 | 15.0 |
| Pigments | 7.37 | 7.37 |
| Total Weight | 140.77 | 170.77 |

Physical Properties

| | | |
|---|---|---|
| Specific Gravity (g/cm³) | 0.77 | 0.82 |
| Heat Deflection Temperature¹ | 64.5° C. | 76.5° C. |
| (° C. at 264 psi) | | |
| Reversion² (% at 170° F.) | 1.36 | 0.16 |
| Reversion (% at 180° F.) | 2.64 | 0.15 |

¹Heat Deflection Temperature was performed according to ASTM 648
²Reversion was performed according to ASTM 4726.

Table 3 shows that a direct comparison of the addition of Blendex HDT modifier increases the heat deflection temperature by 18% and dramatically reduces reversion by over at least 8 times.

The invention is not limited to the above embodiments. The claims follow.

1. A foamable polyvinyl chloride compound, comprising:
polyvinyl chloride,
heat deflection temperature modifier, and
optionally, a blowing agent,
wherein the amount of heat deflection temperature modifier is at least 25 parts per 100 parts of polyvinyl chloride.

2. The compound of claim 1, further comprising lubricant, thermal and ultra-violet light stabilizers, antioxidant, impact modifier, processing aid, filler, pigment, reinforcing material, plasticizer, or combinations thereof.

3. The compound of claim 1, wherein the amount of heat deflection temperature modifier ranges from about 25 to about 100 parts per 100 parts of polyvinyl chloride.

4. The compound of claim 1, wherein the amount of heat deflection temperature modifier ranges from about 40 to about 85 parts per 100 parts of polyvinyl chloride.

5. The compound of claim 1, wherein the amount of optional blowing agent ranges from about 0.01 to about 1 part per 100 parts of polyvinyl chloride.

6. The compound of claim 1, wherein the amount of optional blowing agent ranges from about 0.1 to about 0.8 part per 100 parts of polyvinyl chloride.

7. The compound of claim 1, extruded and foamed in a profile form.

8. The compound of claim 1, mixed and unfoamed in a pellet form.

9. A method of using the compound of claim 8, comprising the steps of: (a) placing pellets of the compound in an extruder to make a foamed compound and (b) extruding the foamed compound through a profile die to make a foamed, extruded profile.

10. The method of claim 9, wherein blowing agent is included in the compound pellets.

11. The method of claim 9, wherein blowing agent is added separately from the compound pellets during step (a).
